(19) United States
(12) Patent Application Publication
(10) Pub. No.: US 2024/0422064 A1
(43) Pub. Date: Dec. 19, 2024

(54) WIRELESS COMMUNICATION METHOD, AND DEVICE AND CHIP

(71) Applicant: GUANGDONG OPPO MOBILE TELECOMMUNICATIONS CORP., LTD., Dongguan (CN)

(72) Inventor: Yang XU, Dongguan (CN)

(21) Appl. No.: 18/817,788

(22) Filed: Aug. 28, 2024

Related U.S. Application Data
(63) Continuation of application No. PCT/CN2022/078902, filed on Mar. 2, 2022.

(51) Int. Cl. H04L 41/0894; H04W 76/10

(52) U.S. Cl. CPC H04L 41/0894; H04W 76/10

(57) ABSTRACT

Provided is a method for wireless communication. The method is applicable to a terminal device, and includes: transmitting first information to a core network element, wherein the first information includes information related to usage of a policy rule configured by a core network for the terminal device, and further includes at least one of: first sub-information, indicating an identified and/or unidentified policy rule; second sub-information, indicating a policy rule used in establishing a packet data unit (PDU) session; third sub-information, indicating a policy rule used for one or more applications; fourth sub-information, indicating the PDU session and/or a network slice used for one or more applications; or fifth sub-information, indicating whether the terminal device uses an updated policy rule and/or indicating a policy rule used by the terminal device.

### CROSS-REFERENCE TO RELATED APPLICATION

This application is a continuation application of International Application No. PCT/CN2022/078902, filed on Mar. 2, 2022, the entire disclosure of which is hereby incorporated herein by reference.

### TECHNICAL FIELD

Embodiments of the present disclosure relates to the technical field of communications, and in particular, relate to a method and apparatus for wireless communication, a communication device, and a storage medium and a program product thereof.

### BACKGROUND

A core network provides some policy rules, for example, a user equipment route selection policy (URSP), an access network discovery and selection policy (ANDSP), or the like, to a terminal device, such that communication between the terminal device and a network side is enabled.

Concerning use of the policy rules configured by the core network for the terminal device, further researches are required currently.

### SUMMARY

Embodiments of the present disclosure provide a method and apparatus for wireless communication, a communication device, and a storage medium and a program product thereof. The technical solutions are as follows.

According to some embodiments of the present disclosure, a method for wireless communication is provided. The method is applicable to a terminal device, and includes:
transmitting first information to a core network element, wherein the first information includes information related to usage of a policy rule configured by a core network for the terminal device.

According to some embodiments of the present disclosure, a method for wireless communication is provided. The method is applicable to a core network element, and includes:
receiving first information from a terminal device, wherein the first information includes information related to usage of a policy rule configured by a core network for the terminal device.

According to some embodiments of the present disclosure, an apparatus for wireless communication is provided. The apparatus includes:
a transmitting module, configured to transmit first information to a core network element, wherein the first information includes information related to usage of a policy rule configured by a core network for the terminal device.

According to some embodiments of the present disclosure, an apparatus for wireless communication is provided. The apparatus includes:
a receiving module, configured to receive first information from a terminal device, wherein the first information includes information related to usage of a policy rule configured by a core network for the terminal device.

According to some embodiments of the present disclosure, a communication device is provided. The communication device includes: a processor and a memory storing one or more computer programs, wherein the processor, when loading and running the one or more computer programs, is caused to perform the method for wireless communication applicable to the terminal device or the method for wireless communication applicable to the core network element.

According to some embodiments of the present disclosure, a computer-readable storage medium is provided. The computer-readable storage medium stores one or more computer programs, wherein the one or more computer programs, when loaded and run by a processor, cause the processor to perform the method for wireless communication applicable to the terminal device or the method for wireless communication applicable to the core network element.

According to some embodiments of the present disclosure, a chip is provided. The chip includes programmable logical circuitry and/or program instructions. The chip, when running, is caused to perform the method for wireless communication applicable to the terminal device or the method for wireless communication applicable to the core network element.

According to some embodiments of the present disclosure, a computer program product or computer program is provided. The computer program product or computer program includes one or more computer instructions stored in a computer-readable storage medium, wherein the one or more computer instructions, when loaded and executed by a processor, cause the processor to perform the method for wireless communication applicable to the terminal device or the method for wireless communication applicable to the core network element.

### BRIEF DESCRIPTION OF DRAWINGS

FIG. 1 is a schematic diagram of a network architecture according to some embodiments of the present disclosure;

FIG. 2 is a schematic architecture diagram of a 5th generation (5G) system according to some embodiments of the present disclosure;

FIG. 3 is an architecture diagram of a 5G system according to some embodiments of the present disclosure;

FIG. 4 is a flowchart of policy configuration of a user equipment (UE) according to some embodiments of the present disclosure;

FIG. 5 is a flowchart of message interaction of a policy control function (PCF) and a UE according to some embodiments of the present disclosure;

FIG. 6 is a flowchart of message interaction of a PCF and a UE according to some embodiments of the present disclosure;

FIG. 7 is a schematic diagram of binding an application data stream to a packet data unit (PDU) session based on a URSP according to some embodiments of the present disclosure;

FIG. 8 is a flowchart of rejection and retry of establishment of a PDU session according to some embodiments of the present disclosure;

FIG. 9 is a flowchart of a method for wireless communication according to some embodiments of the present disclosure;

FIG. 10 is a flowchart of a method for wireless communication according to some embodiments of the present disclosure;

FIGS. 11 to 15 are schematic diagrams of formats of a reply message corresponding to a user equipment configuration update (UCU) message according to some embodiments of the present disclosure;

FIG. 16 is a schematic diagram of a format of a reply message corresponding to a UCU message according to some embodiments of the present disclosure;

FIG. 17 is a flowchart of a method for wireless communication according to some embodiments of the present disclosure;

FIG. 18 is a flowchart of transmission of a registration request message from a UE to a core network element according to some embodiments of the present disclosure;

FIG. 19 is a flowchart of a method for wireless communication according to some embodiments of the present disclosure;

FIG. 20 is a schematic block diagram of an apparatus for wireless communication according to some embodiments of the present disclosure;

FIG. 21 is a schematic block diagram of an apparatus for wireless communication according to some embodiments of the present disclosure;

FIG. 22 is a schematic structural diagram of a terminal device according to some embodiments of the present disclosure; and

FIG. 23 is a schematic structural diagram of a network device according to some embodiments of the present disclosure.

### DETAILED DESCRIPTION

For clearer descriptions of the objectives, technical solutions, and advantages of the present disclosure, embodiments of the present disclosure are described in detail hereinafter in conjunction with the accompanying drawings.

The network architecture and traffic scenarios in the embodiments of the present disclosure are intended to describe the technical solutions in the embodiments of the present disclosure clearer, and are not construed as limitations on the technical solutions in the embodiments of the present disclosure. It can be understood by those of ordinary skill in the art that with the evolution of the network architecture and occurrence of new traffic scenarios, the technical solutions in the embodiments of the present disclosure are also applicable to similar technical problems.

The technical solutions in the embodiments of the present disclosure are applicable to various communication systems, for example, a global system of mobile communications (GSM) system, a code-division multiple access (CDMA) system, a wideband code-division multiple access (WCDMA) system, a general packet radio service (GPRS) system, a long-term evolution (LTE) system, an advanced long-term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), a wireless fidelity (Wi-Fi) system, a 5G system, other communication systems, or the like.

In general, a conventional communication system supports a limited number of connections and is easy to implement. However, with the development of communication technologies, the mobile communication system supports traditional communications and other communications, for example, device-to-device (D2D) communications, machine-to-machine (M2M) communications, machine type communications (MTC), vehicle-to-vehicle (V2V) communications, vehicle-to-everything (V2X) communications, and the like. The communication systems are applicable to the embodiments of the present disclosure.

The communication system in the embodiments of the present disclosure is applicable to a carrier aggregation (CA) scenario, a dual connectivity (DC) scenario, and a standalone (SA) networking scenario.

The communication system in the embodiments of the present disclosure is applicable to an unlicensed spectrum, and the unlicensed spectrum is also construed as a shared spectrum. Alternatively, the communication system in the embodiments of the present disclosure is applicable to a licensed spectrum, and the licensed spectrum is also construed as a non-shared spectrum.

The embodiments of the present disclosure are applicable to the NTN system and a terrestrial network (TN) system.

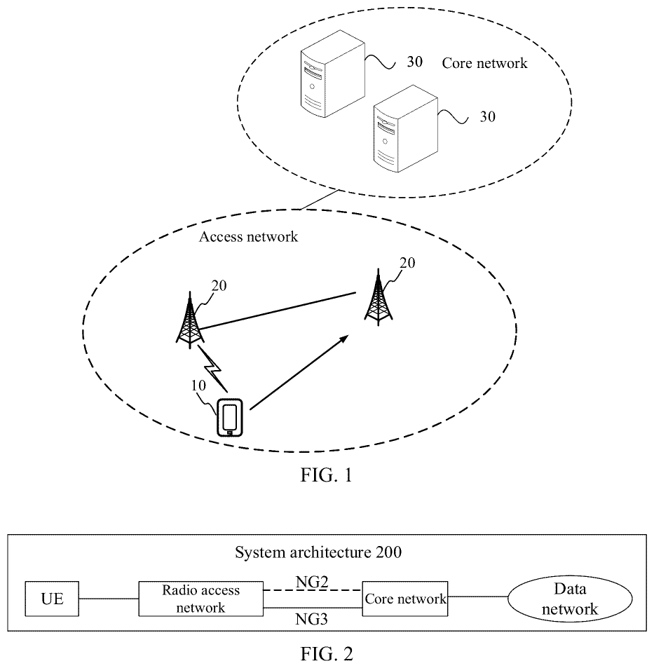

Referring to FIG. 1, a schematic diagram of a network architecture according to some embodiments of the present disclosure is shown. The network architecture includes: a terminal device 10, an access network device 20, and a core network element 30.

The terminal device 10 refers to a UE, an access terminal, a subscriber unit, a user station, a mobile station, a mobile table, a remote station, a remote terminal, a mobile device, a wireless communication device, a user proxy, a user device, or the like. In some embodiments, the terminal device 10 is a cellular phone, a cordless phone, a Session Initiation Protocol (SIP) phone, a wireless local loop (WLL) station, a personal digital assistant (PDA), a hand-held device with a wireless communication capability, a computing device or other processing devices connected to a wireless modem, an in-vehicle device, a wearable device, a terminal device in a 5^{th} generation system (5GS), a terminal device in an evolved public land mobile network (PLMN), or the like, which is not limited in the embodiments of the present disclosure. For convenient description, the above devices are collectively referred to as the terminal device. A plurality of terminal device 10 are generally provided, and one or more terminal devices 10 are disposed in a cell managed by each access network device 20. In the embodiments of the present disclosure, the “terminal device” and the “UE” are exchangeable, and those skilled in the art understand the meanings.

The access network device 20 is a device deployed in the access network and is configured to provide a wireless communication function to the terminal device 10. The access network device 20 includes various forms of macro base stations, micro base stations, relay stations, access points, and the like. In systems adopting different wireless access technologies, names of devices with a function of the access network device are different, for example, referred to as a gNodeB or a gNB in a 5G NR system. With the evolution of the communications technologies, the name of the “access network device” is changed. For convenient description, in the embodiments of the present disclosure, the above devices for providing the wireless communication function to the terminal device 10 are collectively referred to as the access network device. In some embodiments, the terminal device 10 communicates with the core network element 30 by the access network device 20. Illustratively, in the LTE system, the access network device 20 is an evolved universal terrestrial radio access network (EUTRAN) or one or more eNodeBs in the EUTRAN; in the 5G NR system, the access network device 20 is a radio access network (RAN) or one or more gNBs in the RAN.

The core network element 30 is a network element deployed in the core network. The core network element 30 mainly functions as providing user connection, managing the user, and carrying the traffic, and is used as a bearer network for providing an access to an external network. For example, the core network element of the 5G NR system includes an access and mobility management function (AMF), a user plane function (UPF), a session management function (SMF), and other network elements. In addition, the core network element is determined as a function entity, and one or more core network elements are deployed on a physical device.

In some embodiments, the access network device 20 and the core network element 30 communicate with each other using an air interface technology, such as an NG interface in the 5G NR system. The access network device 20 and the terminal device 10 communicate with each other using the air interface technology, for example, over a Uu interface.

The “5G NR system” in the embodiments of the present disclosure is also referred to as a 5G system or an NR system, and those skilled in the art understand the meanings. The technical solutions according to the embodiments of the present disclosure are applicable to the LTE system, the 5G NR system, an evolution system of the 5G NR system, and other communication systems such as a narrow band Internet of things (NB-IoT), which is not limited in the present disclosure.

In the embodiments of the present disclosure, the access network device provides services for cells, and the terminal device communicates with the access network device through the transmission resources (such as frequency domain resources, or spectrum resources) in carriers used in the cells. The cell is a cell corresponding to the access network device (such as a base station), and the cell belongs to a macro base station or a base station corresponding to a small cell. The small cell includes a metro cell, a micro cell, a pico cell, a femto cell, or the like. The small cells have the small coverage and low transmission power, and are suitable for providing high rate data transmission services.

Referring to FIG. 2, a schematic diagram of a system architecture of a 5GS according to some embodiments of the present disclosure is shown. As shown in FIG. 2, the system architecture 200 includes the UE (that is the “terminal device” described above), the (R)AN, the core network, and a data network (DN). The UE, the (R)AN, and the core network are main elements of the architecture, and are logically arranged into two portions of a use side and a control side. The control side manages a mobile network, and the user side transmits traffic data. In the drawings, an NG2 reference point is configured between a (R)AN control side and a core network control side, an NG3 reference point is configured between a (R)AN user side and a core network user side, and an NG6 reference point is configured between the core network user side and the DN.

The UE is an access of interaction of a mobile user and the network, and is capable of providing essential computing capability and storing capability, displaying a traffic window to the user, and receiving operation input of the user. The UE establishes signal connection and data connection with the (R)AN by the next generation air interface technology, and hence transmits control signals and traffic data to the mobile network.

The (R)AN is similar to a base station in a conventional network, is deployed close to the UE, provides a network access function for authorized users within a specific area, and transmits user data based on levels of the users, requirements of traffics, and the like over transmission channels with different qualities. The (R)AN is capable of managing and reasonably using its own resources, providing access services for the UE on demand, and forwarding the control signals and the user data between the UE and the core network.

The core network maintains subscription data of the mobile network, manages network elements of the mobile network, and provides session management, mobility management, policy management, security authentication, and other functions to the UE. In the case that the UE is attached, the core network provides a network access authentication to the UE. In the case that the UE initiates a traffic request, the core network allocates network resources to the UE. In the case that the UE moves, the core network updates network resources for the UE. In the case that the UE is idle, the core network provides a quick resumption mechanism for the UE. In the case that the UE is unattached, the core network releases the network resources for the UE. In the case that the UE has traffic data, the core network provides data routing functions to the UE, for example, a function of forwarding uplink data to the DN, or receiving UE downlink data from the DN, forwarding the UE downlink data to the (R)AN, and transmitting the UE downlink data to the UE.

The DN is a data network for providing the traffic service to the users. Generally, a client is disposed in the UE, and a server end is disposed in the data network. The data network is a private network (for example, a local area network), an external network not controlled by the carrier (for example, the Internet), or a proprietary network jointly deployed by the carriers (for example, for configuring an Internet Protocol (IP) multimedia core network subsystem (IMS) service).

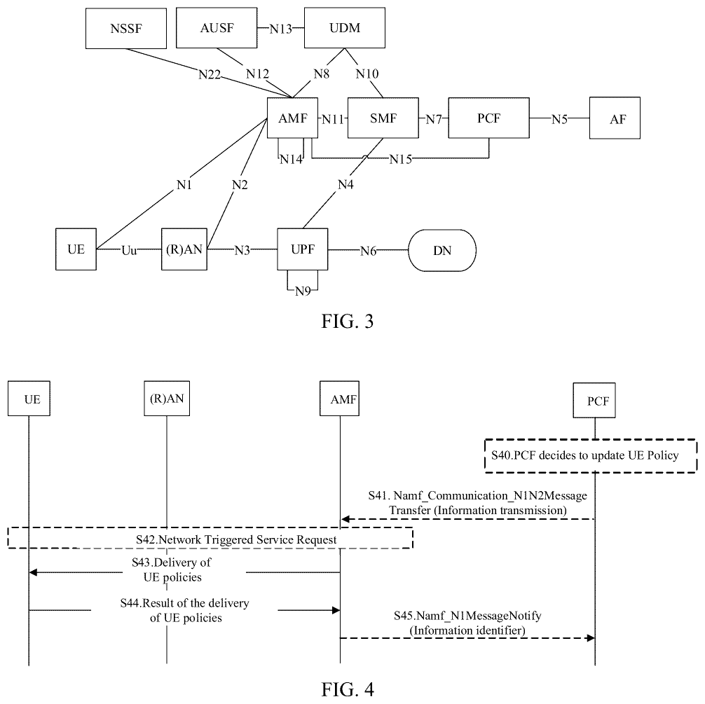

FIG. 3 is a detailed architecture determined based on FIG. 2. The core network user side includes the UPF, and the core network control side includes an authentication server function (AUSF), the AMF, the SMF, a network slice selection function (NSSF), a network exposure function (NEF), a network repository function (NRF), a unified data management (UDM), the PCF, and an application function (AF).

In the architecture shown in FIG. 3, the UE and the (R)AN achieve access stratum (AS) connection, AS message interaction and wireless data transmission over the Uu interface, and the UE and the AMF achieve non access stratum (NAS) connection and NAS message interaction over the N1 interface. The AMF indicates the mobility management in the core network, and the SMF indicates the session management function in the core network. The AMF performs the mobility management on the UE, and forwards session management-related information between the UE and the SMF. The PCF indicates the policy management function in the core network, and develops policies related to the mobility management, the session management, charging, and the like on the UE. The UPF indicates the user side function in the core network, and achieves data transmission to the external network over the N6 interface and achieves data transmission to the (R)AN over the N3 interface.

It should be noted that names of the interfaces between various network elements in FIG. 2 and FIG. 3 are exemplary, and the names of the interfaces may be otherwise defined in specific implementations, which are not specifically limited in the embodiments of the present disclosure. The various network elements (for example, the SMF, the AF, the UPF, and the like) in FIG. 2 and FIG. 3 are also exemplarily named, and the names of the network elements do not limit the functions thereof. In the 5GS and other future networks, the network elements may have other names, which are not specifically limited in the embodiments of the present disclosure. For example, in the 6G network, some or all of the network elements follow the terms in the 5G in terms of naming, or have other names, or the like, which are unified herein and are not described hereinafter. In addition, it should be understood that names of messages (or signaling) transmitted between the network elements are also exemplary, and do not limit the functions of the messages.

In some embodiments, the network elements related to the policies are mainly the PCF, the AMF, the SMF, the RAN, and the UE. The SMF mainly performs the policy related to the session, the AMF mainly performs the policy related to the access and the UE policy, and the issue and update of the policy in the two network elements (the AMF and the SMF) are controlled by the PCF.

For the UE policy, information related to the UE policy, including content of the UE policy, UE policy identifier, and the like, is monitored by the container between the PCF and the UE. The container is transmitted to the AMF by the UE through the NAS message in an uplink direction, and is continuously transmitted (not sensed or modified) to the PCF by the AMF. On the contrary, in the downlink direction, the PCF transmits the container to the AMF, and the AMF transmits the container to the UE through the NAS message.

Prior to description of the technical solutions according to the present disclosure, some background technical knowledge involved in the present disclosure are introduced. The following related arts may be determined as optional solutions and may be arbitrarily combined with the technical solutions according to the embodiments of the present disclosure, which shall fall within the scope of the protection of the embodiments of the present disclosure. The embodiments of the present disclosure include at least some of the following content.

### 1. A Configuration Procedure of the UE Policy.

Referring to FIG. 4, a flowchart of policy configuration of a UE policy is shown. Configuration or update of the UE policy is achieved by the UCU procedure defined in the 3^{rd} generation partnership project (3GPP). As shown in FIG. 4, the configuration procedure of the UE policy is as follows.
S40, a PCF decides to update UE policy.
S41, Namf_Communication_NIN2Message Transfer (a message for updating the UE policy is transmitted to a UE by calling a message transmission service of an AMF).
S42, network triggered service request.
S43, delivery of UE policies.
S44, result of the delivery of UE policies.
S45, Namf_N1MessageNotify (the AMF calls a message notification service to transmit the result of the delivery of UE policies to the PCF).

The configuration or update procedure of the UE policy achieved by the UCU shown in FIG. 4 is summarized as follows: the PCF places a policy to be updated in a container and transmits the container to the AMF, and the AMF forwards (for example, transmits) the container to the UE through the NAS message.

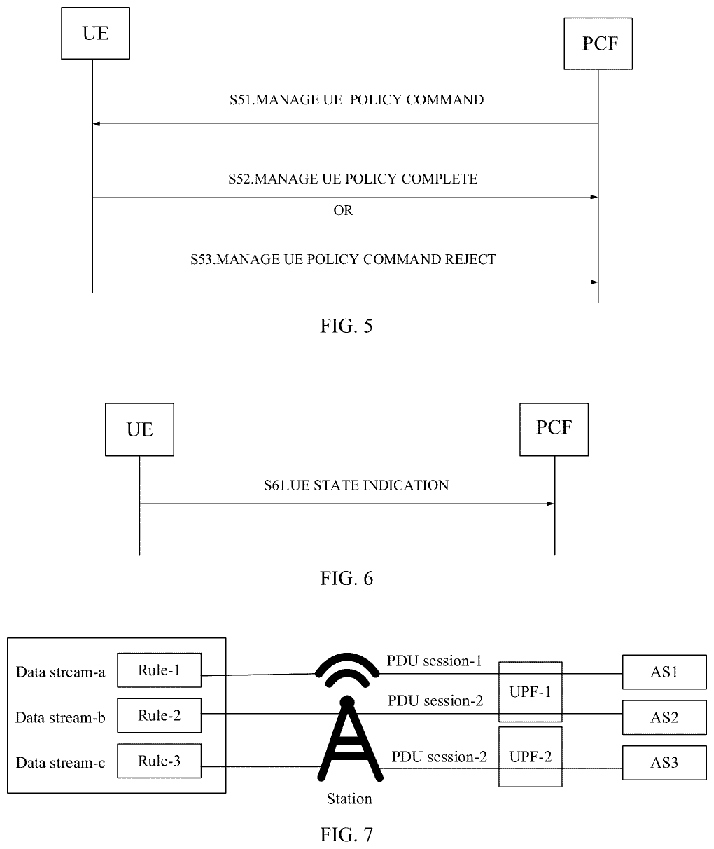

For transmission of the UE policy, a Cause of the “UE policy container” is introduced to an uplink NAS and a downlink NSA message, that is, the Cause of the “UE policy container” is added by a payload container. The AMF immediately performs a transmit function in response to acquiring the Cause in the payload container. The “UE policy container” is configured to carry the message between the PCF and the UE, as shown in FIG. 5.
S51, MANAGE UE POLICY COMMAND (a PCF transmits a UE policy manage command message to a UE).
S52 or S53 is performed subsequent to S51.
S52, MANAGE UE POLICY COMPLETE (the UE transmits a UE policy manage complete message to the PCF).
S53, MANAGE UE POLICY COMMAND REJECT (the UE transmits a UE policy manage reject message to the PCF).

In addition, as shown in FIG. 6, S61: MANAGE UE POLICY COMMAND REJECT (a UE transmits a UE state indication message to a PCF), and the UE may actively transmit the UE state indication message to the PCF to inform the PCF the related state information of the UE.

### 2. Use of the UE Policy.

The UE policy includes the URSP policy, the ANDSP policy, and the like, and the URSP policy determines a binding relationship between application data and the PDU session and determines which PDU session to be established by the UE to meet the binding relationship.

Referring to FIG. 7, a schematic diagram of binding an application data stream to a PDU session based on a URSP policy is shown.

Illustratively, each PDU session corresponds to one set of attribute parameters of the PDU session. Illustratively, different application data streams are bound to different PDU sessions based on the URSP rule. In some embodiments, different application data streams are bound to a same PDU session based on the URSP rule, which is not limited herein.

Illustratively, each PDU session has corresponding attribute parameters, and the attribute parameters include, but are not limited to, single-network slice selection assistance information (S-NSSAI), a data network name (DNN), a PDU session type, and a service and session continuity (SSC) mode.

In some embodiments, in the case that the UE initiates a PDU session establishment request, the attribute parameters are carried. In some embodiments, in the case that the UE initiates a PDU session establishment request, some parameters are not carried, and corresponding attribute parameters are filled by a network side device. Illustratively, in the case that the PDU session establishment request includes a PDU session id being 1, DNN being 1, and the PDU session type being IPv4, the SMF receives the request and fills other attribute parameters: S-NSSAI being 1, SSC Mode being 1. Illustratively, the UE and the network side store attribute parameters carried in the PDU session that is successfully established, and the attribute parameters includes attribute parameters carried in the PDU session establishment request from the UE and attribute parameters filled on the network side.

Referring to Table 1, a list of traffic descriptors and corresponding route selection descriptors (RSDs) in the URSP rule is shown. Referring to Table 2, detailed parameters in the RSD are shown.

In some embodiments, the traffic descriptor in the URSP rule is configured to describe a specific traffic, for example, the application data stream shown in FIG. 7. For example, a micro-blog traffic is described by an IP@1˜9 range, an Internet Protocol (IP) multimedia subsystem (IMS) traffic is described by an IMS DNN. In some embodiments, a traffic descriptor includes one or more RSDs. In some embodiments, a value of S-NSSAI and a value of DNN in the RSD are one or more, and other parameters in the RSD only includes one value. Thus, each RSD corresponds to one or more components of parameters, each of the components of parameters is referred to as a feature of a set of PDU sessions, and traffic data corresponding to the traffic descriptor is transmitted in a PDU session corresponding to a component of parameters of the RSD. In the case that the application data stream described by the traffic descriptor emerges, the UE selects a component of parameters based on a value of a component of the corresponding RSD to initiate a PDU session establishment request. In some embodiments, each time the UE initiates a PDU session establishment request, a set of session data parameters are carried in the request message, which is a component of parameter values in the RSD table of an URSP rule.

TABLE 1
List of traffic descriptors and corresponding RSDs in a URSP rule

| | | | PCF permitted to | |
|---|---|---|---|---|
| Information | | | modify in a UE | |
| name | Description | Category | context | Scope |
| Rule | Determines the order | Mandatory | Yes | UE context |
| Precedence | the URSP rule is | (NOTE 1) | | |
| | enforced in the UE. | | | |
| Traffic | This part defines | Mandatory | | |
| descriptor | the Traffic | (NOTE 3) | | |
| | descriptor components | | | |
| | for the URSP rule. | | | |
| Application | It consists of | Optional | Yes | UE context |
| descriptors | OSId and OSAppId(s). | | | |
| | (NOTE 2) | | | |
| IP | Destination IP 3 tuple(s) | Optional | Yes | UE context |
| descriptors | (IP address or IPv6 | | | |
| (NOTE 5) | network prefix, | | | |
| | port number, | | | |
| | protocol ID of the | | | |
| | protocol above IP). | | | |
| Domain | Destination FQDN(s) | Optional | Yes | UE context |
| descriptors | | | | |
| Non-IP | Descriptor(s) for | Optional | Yes | UE context |
| descriptors | destination | | | |
| (NOTE 5) | information of | | | |
| | non-IP traffic | | | |
| DNN | This is matched | Optional | Yes | UE context |
| | against the DNN | | | |
| | information | | | |
| | provided by the | | | |
| | application. | | | |
| Connection | This is matched | Optional | Yes | UE context |
| Capabilities | against the | | | |
| | information | | | |
| | provided by a UE | | | |
| | application when | | | |
| | it requests a | | | |
| | network connection | | | |
| | with certain | | | |
| | capabilities. | | | |
| | (NOTE 4) | | | |
| List of Route | A list of Route | Mandatory | | |
| Selection | Selection | | | |
| Descriptors | Descriptors. The | | | |
| | components of a | | | |
| | Route Selection | | | |
| | Descriptor are | | | |
| | described in | | | |
| | table 6.6.2.1-3. | | | |

TABLE 2
Parameters of RSDs

| Information | | | PCF permitted to | |
|---|---|---|---|---|
| name | Description | Category | modify in URSP | Scope |
| Route Selection | Determines the | Mandatory | Yes | UE context |
| Descriptor | order in which | (NOTE 1) | | |
| Precedence | the Route Selection | | | |
| | Descriptors are | | | |
| | to be applied. | | | |
| Route selection | This part defines | Mandatory | | |
| components | the route | (NOTE 2) | | |
| | selection components | | | |
| SSC Mode | One single value | Optional | Yes | UE context |
| Selection | of SSC mode. | | | |
| | (NOTE 5) | | | |
| Network Slice | Either a single | Optional | Yes | UE context |
| Selection | value or a list | (NOTE 3) | | |
| | of values | | | |
| | of S-NSSAI(s). | | | |
| DNN Selection | Either a single | Optional | Yes | UE context |
| | value or a list | | | |
| | of values | | | |
| | of DNN(s). | | | |
| PDU Session | One single | Optional | Yes | UE context |
| Type Selection | value of PDU | | | |
| | Session Type | | | |
| Non-Seamless | Indicates if the | Optional | Yes | UE context |
| Offload | traffic of the | (NOTE 4) | | |
| indication | matching application | | | |
| | is to be offloaded | | | |
| | to non-3GPP access | | | |
| | outside of a PDU | | | |
| | Session. | | | |
| Access Type | Indicates the | Optional | Yes | UE context |
| preference | preferred Access | | | |
| | Type (3GPP or | | | |
| | non-3GPP or | | | |
| | Multi-Access) | | | |
| | when the UE | | | |
| | establishes a PDU | | | |
| | Session for | | | |
| | the matching | | | |
| | application. | | | |

In some embodiments, as shown in FIG. 7, the UE associates the application data stream with the corresponding PDU session based on the URSP rule for transmission, and the mechanism is as follows.

In the case that the data stream emerges in an application layer, the UE checks, using the USEP rule in the URSP policy, whether a feature of the application data is matched with the traffic descriptor of a rule in the URSP rule, and the checking sequence is determined based on the rule precedence in the URSP rule, that is Table 1. In some embodiments, the UE sequentially checks a match condition based on a sequence of the precedence, and the PDU session is bound using an RSD list in the URSP rule in the case that the URSP rule is matched.

In the case that the URSP rule is matched, the UE first checks whether the currently established PDU session includes valid RSD parameters in the matched URSP rule, and the matched application data is bound to the PDU session for transmission in the case that the currently established PDU session includes valid RSD parameters in the matched URSP rule. Otherwise, the PDU session is established based on the precedence of the valid RSD, and the RSD parameter with higher precedence is first used to establish the PDU session. In the case that a parameter in the RSD has one or more values, the UE selects one of the values to establish the PDU session in conjunction with other parameters. In the case that the session is successfully established, the UE binds the application data to the session for transmission; and in the case that the session is not successfully established, the UE retries to establish the PDU session based on another component of parameters in the RSD or using a component of parameters in an RSD with a secondary precedence.

In the case that no suitable PDU session is searched based on all parameters in the match URSP rule for binding, the UE checks, based on the sequence of the precedence, whether the traffic descriptor in a URSP rule with a secondary precedence matches the feature of the application data stream, and the above processes are repeated in the case that the traffic descriptor in the URSP rule with the secondary precedence matches the feature of the application data stream.

The above procedure of searching a suitable PDU session for the application is referred to as the “evaluation,” that is, the suitable PDU session is searched or established. The RSD in the URSP rule used by the UE is determined as the valid RSD for performing the above evaluation procedure in the case that the following conditions are met:
in the case that the RSD includes the S-NSSAI, the S-NSSAI should belong to one of allowed NSSAI and mapping of allowed NSSAI;
in the case that the RSD includes the DNN, and the DNN is a local area data network (LADN) DNN, the UE should be configured in a valid range corresponding to the LADN;
in the case that the RSD includes an access type preference, and the access type preference is set as a multi-access, the UE should support an access traffic steering, switching, splitting (ATSSS) function;
in the case that the RSD includes a timer window and a location criterion, the UE should meet a desired time and location condition;
otherwise, the UE does not bind the data stream or establish the PDU session using the RSD. Based on the above evaluation procedure mechanism, the UE requests to establish the PDU session again in the case that the PDU session establishment is rejected.

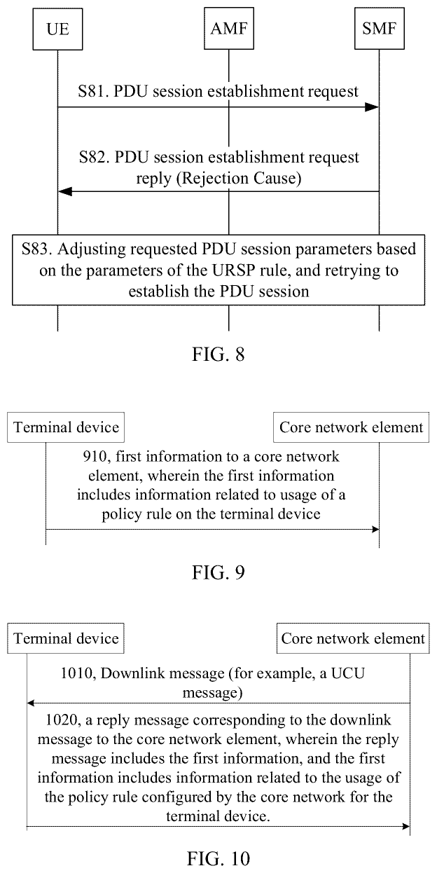

As shown in FIG. 8, a flowchart of rejection and retry of establishment of a PDU session is illustrated.

In S81, a UE transmits a PDU session establishment request to an SMF.

The UE carries PDU session parameters in a PDU session establishment request message. Illustratively, the PDU session parameters includes one or more of: the DNN, the S-NSSAI, the PDU Session Type, the SSC Mode, and the PDU Session ID.

In S82, the SMF transmits a PDU session establishment request reply (Rejection Cause) to the UE.

The SMF transmits the PDU session establishment request reply to the UE. In the case that the SMF rejects the PDU session establishment request, the PDU session establishment request reply includes the Rejection Cause.

In S83, the UE adjusts requested PDU session parameters based on the parameters of the URSP rule, and retry to establish the PDU session.

The UE adjusts the parameter component based on the RSD parameters in the URSP rule and reinitiates the PDU session establishment.

The current URSP mechanism has the following problems.
1) The parameters of the URSP rule, for example, application descriptor parameters in the traffic descriptor, may be not identified by the terminal device. The cause includes that some parameters need coordination between the operator and the terminal company, which is not only determined by the operator. The current evaluation rule states that in the case that a terminal device does not identify the parameters of the URSP rule, the URSP rule is automatically ignored. However, the terminal device does not inform the network side which URSP rule or the RSD therein is ignored.

Problem 1: Some URSP rules from the network side may be never performed by the terminal device, but the network side does not know this situation.
2) In the case that the terminal device receives a new URSP rule, the terminal device reevaluates the URSP rule, and determines a new binding relationship between the application data stream and the PDU session based on the new URSP rule. However, when to evaluate the new URSP rule and when to perform the new binding relationship by the terminal device are determined by the terminal device.

Problem 2: When to perform the new URSP rule to bind the application data stream by the terminal device is not determined in the case that the network updates the URSP rule for the terminal device.
3) For each application data stream, the PDU session corresponding to the RSD in the URSP rule is selected based on the evaluation rule for data transmission. Then, the binding relationship is not changed for a subsequent period.

Problem 3: The URSP rule and the RSD used by the terminal device for a specific application data stream may be not have the highest precedence, but the network side does not determine which URSP rule and RSD is used by the terminal device for the application.

Thus, only the terminal device knows current state information of execution of the UE policy (particularly the URSP policy), whereas the network side does not know the state information and thus does not determine whether parameters transmitted to the terminal device are used or executed as desired. Thus, a mechanism is required for the network side to determine that the terminal device is executing the UE policy rule.

In the present disclosure, the first information is transmitted to the core network element by the terminal device, and the first information includes information related to the usage of the policy rule configured by the core network for the terminal device, such that the core network element acquires the usage of the policy rule on the terminal device, the subsequent UE policy planning and UE policy update are facilitated, and hence the communication reliability is improved.

The technical solutions according to the present disclosure are described in conjunction with some embodiments hereinafter.

Referring to FIG. 9, a flowchart of a method for wireless communication according to some embodiments of the present disclosure is shown. The method is applicable to the network architecture shown in FIG. 1 to FIG. 3. The method includes the following processes.

In S910, a terminal device transmits first information to a core network element, wherein the first information includes information related to usage of a policy rule on the terminal device.

Correspondingly, the core network element receives the first information from the terminal device.

In some embodiments, the policy rule is configured by the core network. In some embodiments, the first information includes the information related to the usage of the policy rule, configured by the core network for the terminal device.

The policy rule indicates a policy or a rule configured by a carrier or a manufacturer for the terminal device and instructing the terminal device to perform related communication behaviors. The policy rule in the present disclosure is also referred to as a UE policy, a UE rule, or other names, which is not limited in the present disclosure. In some embodiments, the policy rule includes, but is not limited to, the URSP, a vehicle-to-everything policy (V2XP), a proximity service policy (ProSeP), or the ANDSP).

In some embodiments, the usage of the policy rule on the terminal device indicates whether the terminal device identifies one or some policy rules. For example, the first information indicates that the terminal device identifies a policy rule identified and/or unidentified by the terminal device. It should be noted that the above phrase “identified/unidentified” may be construed as “recognized/unrecognized,” “supported/unsupported,” or “used/unused” in some scenarios, which is not limited in the present disclosure.

In addition, the above policy rule is configured by the core network, for example, configured by the PCF of the core network element. Correspondingly, the terminal device transmits the first information to the PCF, and the first information includes the information related to the usage of the policy rule configured by the PCF for the terminal device. In some embodiments, the AMF does not sense the first information, and directly transmits the downlink message to the PCF. In some embodiments, the AMF does not modify the first information, but directly transmits the first information to the PCF.

In some embodiments, the first information further includes at least one of:
first sub-information, indicating an identified and/or unidentified policy rule;
second sub-information, indicating a policy rule used in establishing a PDU session;
third sub-information, indicating a policy rule used for one or more applications;
fourth sub-information, indicating the PDU session and/or a network slice used for one or more applications; or
fifth sub-information, indicating whether the terminal device uses an updated policy rule and/or indicating a policy rule used by the terminal device.

For the above first sub-information, illustrative descriptions are as follows.

In some embodiments, the first sub-information indicates the identified policy rule. For example, the first sub-information indicates that one or more policy rules are identified. For example, the first sub-information includes first indication information indicating identification of the policy rule. For example, the first sub-information includes identification information of at least one identified policy rule.

In some embodiments, the first sub-information indicates the unidentified policy rule. For example, the first sub-information indicates that one or more policy rules are not identified. For example, the first sub-information includes second indication information indicating un-identification of the policy rule. For example, the first sub-information includes identification information of at least one unidentified policy rule.

In some embodiments, the first sub-information indicates the identified policy rule and the unidentified policy rule. For example, the first sub-information indicates that one or more policy rules are identified and one or more policy rules are not identified. For example, the first sub-information includes the first indication information indicating identification of the policy rule and the identification information of at least one identified policy rule corresponding to the first indication information, and the first sub-information further includes the second indication information indicating un-identification of the policy rule and the identification information of at least one unidentified policy rule corresponding to the second indication information.

For the above second sub-information, illustrative descriptions are given as follows.

In some embodiments, the second sub-information indicates the policy rule used in establishing one or more PDU sessions.

In some embodiments, the second sub-information includes at least one set of mapping relationship between identification information of the PDU session and identification information of the policy rule, and each set of mapping relationship indicates the policy rule used in establishing the PDU session.

In some embodiments, the second sub-information includes identification information of at least one policy rule, and does not include the identification information of the PDU session. The core network element determines, based on the identification information of the policy rule, that one or more PDU sessions are established by using the policy rule corresponding to the identification information. The above one or more PDU sessions are determined as a last-established PDU session, a PDU session transmitting the data stream currently, a PDU session including to-be-transmitted data stream currently, a PDU session used by a contract traffic or data stream, or the like by default, which is not limited in the present disclosure.

In some embodiments, the second sub-information includes identification information of at least one PDU session, and does not include the identification information of the policy rule. The core network element determines, based on the identification information of the PDU session, that one or more policy rules are policy rules used to establish the PDU session. The one or more policy rules are determined as a policy rule latest-configured by the core network, a policy rule configured by the core network within a contract time/period, or the like by default, which is not limited in the present disclosure.

In some embodiments, the second sub-information only includes the first indication information indicating identification (or use) of the policy rule, or includes the second indication information indicating un-identification (or unuse) of the policy rule, but does not include the identification information of the PDU session and the identification information of the policy rule. The core network element determines, based on the first indication information or the second indication information, that one or more PDU sessions are established by using or not using the policy rule. The above one or more PDU sessions are determined as a last-established PDU session, a PDU session transmitting the data stream currently, a PDU session including to-be-transmitted data stream currently, a PDU session used by a contract traffic or data stream, or the like by default, and the above one or more policy rules are determined as a policy rule latest-configured by the core network, a policy rule configured by the core network within a contract time/period, or the like by default, which are not limited in the present disclosure.

In some embodiments, the second sub-information further indicates the mapping relationship between the PDU session and the policy rule used in establishing the PDU session. A policy rule has a mapping relationship with one or more policy rules, and a policy rule has a mapping relationship with one or more PDU sessions. Illustratively, the second sub-information includes a mapping relationship between the identification information of the PDU session and the identification information of the policy rule used in establishing the PDU session.

In addition, the policy rule used in establishing the PDU session includes the URSP, and other policy rules, which is not limited in the present disclosure.

For the above third sub-information, illustrative descriptions are as follows.

In some embodiments, the third sub-information includes at least one set of mapping relationship between identification information of the application and identification information of the policy rule, and each set of mapping relationship indicates the policy rule used for the application.

In some embodiments, the third sub-information further includes the identification information of at least one policy rule, and does not include the identification information of the application. The core network element determines, based on the identification information of the policy rule, that one or more applications use the policy rule corresponding to the identification information. For example, the core network element determines that the data stream of the one or more applications are transmitted by the PDU session established by the policy rule corresponding to the identification information. The above one or more applications are determined as an application transmitting the data stream currently, an application including to-be-transmitted data stream currently, one or more contract applications, or the like by default, which is not limited in the present disclosure.

In some embodiments, the third sub-information further includes the identification information of at least one application, and does not include the identification information of the policy rule. The core network element determines, based on the identification information of the application, that one or more policy rules are used by the application indicated by the identification information. The above one or more policy rules are determined as a policy rule latest-configured by the core network, a policy rule configured by the core network within a contract time/period, or the like by default, which are not limited in the present disclosure.

In some embodiments, the third sub-information only includes the first indication information indicating identification (or use) of the policy rule, or includes the second indication information indicating un-identification (or unuse) of the policy rule, but does not include the identification information of the application and the identification information of the policy rule. The core network element determines, based on the first indication information or the second indication information, that one or more applications use or do not use one or more policy rules. The above one or more applications are determined as an application transmitting the data stream currently, an application including to-be-transmitted data stream currently, one or more contract applications, or the like by default, and the above one or more policy rules are determined as a policy rule latest-configured by the core network, a policy rule configured by the core network within a contract time/period, or the like by default, which are not limited in the present disclosure.

In some embodiments, the third sub-information indicates at least one policy rule used for the applications at different times or within different periods. The same application uses different policy rules or the same policy rule at different times or within different periods. In some embodiments, the third sub-information further includes at least one set of mapping relationship between the time/period and the policy rule, and each set of mapping relationship indicates the policy rule used at the time/within the period.

For the above fourth sub-information, illustrative descriptions are as follows.

In some embodiments, the fourth sub-information includes at least one set of mapping relationship between identification information of the application and identification information of the PDU session and/or network slice, and each set of mapping relationship indicates the PDU session and/or the network slice used for the application.

In some embodiments, the fourth sub-information further includes the identification information of at least one PDU session and/or network slice, and does not include the identification information of the application. The core network element determines, based on the identification information of the PDU session and/or network slice, that one or more applications use the PDU session and/or network slice corresponding to the identification information. For example, the core network element determines that the data stream of the one or more applications are transmitted by the PDU session and/or network slice corresponding to the identification information. The above one or more applications are determined as an application transmitting the data stream currently, an application including to-be-transmitted data stream currently, one or more contract applications, or the like by default, which is not limited in the present disclosure.

In some embodiments, the fourth sub-information further includes the identification information of at least one application, and does not include the identification information of the PDU session and/or network slice. The core network element determines, based on the identification information of the application, that one or more PDU sessions and/or network slices are used by the application indicated by the identification information. The above one or more PDU sessions and/or network slices are determined as one or more contract PDU sessions and/or network slices, for example, a last-established PDU session and/or network slice, a PDU session and/or network slice transmitting the data stream currently, a PDU session and/or network slice including to-be-transmitted data stream currently, or the like by default, which is not limited in the present disclosure.

In some embodiments, the fourth sub-information only includes the first indication information indicating identification (or use) of the policy rule, or includes the second indication information indicating un-identification (or unuse) of the policy rule, but does not include the identification information of the application and the identification information of the PDU session and/or network slice. The core network element determines, based on the first indication information or the second indication information, that one or more applications use or do not use one or more PDU sessions and/or network slices. The above one or more applications are determined as an application transmitting the data stream currently, an application including to-be-transmitted data stream currently, one or more contract applications, or the like by default, and the above one or more PDU sessions and/or network slices are determined as one or more contract PDU sessions and/or network slices, for example, a last-established PDU session and/or network slice, a PDU session and/or network slice transmitting the data stream currently, a PDU session and/or network slice including to-be-transmitted data stream currently, or the like by default, which are not limited in the present disclosure.

For the above fifth sub-information, illustrative descriptions are as follows.

In some embodiments, the fifth sub-information indicates whether the terminal device uses an updated policy rule. For example, the fifth sub-information indicates that the terminal device uses the updated policy rule, or the terminal device does not use the updated policy rule. The above updated policy rule is updated by the core network element based on a downlink message, for example, the UCU message, or other messages, which is not limited in the present disclosure. In some embodiments, the fifth sub-information includes one-bit indication information, and indicates whether the terminal device uses the updated policy rule.

In some embodiments, the fifth sub-information indicates a policy rule used by the terminal device. It should be noted that the term “used” herein indicates “already used” or “being used.” For example, the fifth sub-information indicates a policy rule already used by the terminal device, or the fifth sub-information indicates a policy rule being used by the terminal device. In some embodiments, the fifth sub-information includes identification information of the policy rule used by the terminal device to indicate the policy rule used by the terminal device.

In some embodiments, the fifth sub-information indicates whether the terminal device uses the updated policy rule, and indicates the policy rule used by the terminal device. Similarly, the term “used” herein indicates “already used” or “being used.” That is, in the embodiments, the fifth sub-information has the above two functions.

In some embodiments, the network slice has different identifiers (for example, the S-NSSAI, a network slice instances ID (NSI ID), and the like). By taking the S-NSSAI ID as an example, different network slices have different S-NSSAI, and the terminal device and the core network element distinguish different network slices based on the S-NSSAI.

In addition, it should be noted that as the fourth sub-information indicates the PDU session and/or network slice used for the one or more applications, and the PDU session and/or network slice has a mapping relationship with the policy rule, the policy rule used for one or more applications is indicated.

In some embodiments, identification of the policy rule includes at least one of: identifying the policy rule using a rule ID of the policy rule; or identifying the policy rule using one or more parameters of the policy rule. That is, the identification information of the policy rule is represented by the rule ID (short for ID) of the policy rule or one or more parameters of the policy rule.

Identifying the policy rule using the rule ID of the policy rule indicates unique identification of the policy rule by the rule ID. In some embodiments, the policy rule used by the terminal device is the URSP rule, and thus the URSP rule ID identifies the URSP rule. In some embodiments, the RSD ID identifies the RSD. For example, the URSP rule ID and the RSD ID identify the URSP rule and the RSD in the URSP rule.

Identifying the policy rule using one or more parameters of the policy rule indicates unique identification of the policy rule by one or more parameters of the policy rule. In some embodiments, the policy rule used by the terminal device is the URSP rule, and thus the traffic descriptor or the rule precedence identifies the URSP rule. In some embodiments, the precedence or route selection components of the RSD identifies the RSD. For example, the traffic descriptor/rule precedence in the URSP rule and the precedence/route selection components of the RSD identify the URSP rule and the RSD in the URSP rule.

In some embodiments, in the case that the policy rule is unique, the policy rule indicated by the first information includes the URSP rule and/or at least one RSD in the URSP rule.

In the technical solutions according to the embodiments of the present disclosure, the first information is transmitted to the core network element by the terminal device, and the first information includes information related to the usage of the policy rule configured by the core network for the terminal device, such that the core network element acquires the usage of the policy rule on the terminal device, and subsequent configuration and update of the policy rule are facilitated, and the communication reliability is improved.

Referring to FIG. 10, a flowchart of a method for wireless communication according to some embodiments of the present disclosure is provided. The method is applicable to the network architecture shown in FIG. 1 to FIG. 3. The method includes at least one of the following processes (S1010 to S1020).

In S1010, a core network element transmits a downlink message to a terminal device.

In some embodiments, the downlink message includes a policy rule configured by the core network for the terminal device. For example, the downlink message includes a URSP rule configured by the core network for the terminal device. The URSP rule is only illustrative, and the downlink message may include other policy rules described above, which is not limited in the present disclosure. In addition, for descriptions of related policy rules, reference may be made to content in other embodiments herein, which is not described again in the embodiments.

In some embodiments, the core network element is the PCF. In the case that the PCF tends to transmit the downlink message to the terminal device, the PCF needs to transmit the downlink message to the AMF, and the AMF forwards the downlink message to the terminal device. In some embodiments, the AMF does not sense/modify the downlink message and directly transmits the downlink message from the PCF to the terminal device.

In some embodiments, the downlink message is the UCU message. In some embodiments, the UCU message is a message transmitted by the core network element to the terminal device for instructing the terminal device to update configuration. In some embodiments, the core network element is the PCF. The PCF places the UCU message in a third container and transmits the UCU message to the AMF through the third container, and the UCU message is transmitted to the terminal device through the AMF.

Correspondingly, the terminal device receives the downlink message from the core network element.

In S1020, the terminal device transmits a reply message corresponding to the downlink message to the core network element, wherein the reply message includes the first information. The first information includes information related to the usage of the policy rule configured by the core network for the terminal device.

For descriptions of the first information, reference may be made to content in other embodiments herein, which are not described again in the embodiments.

Correspondingly, the core network element receives the reply message from the terminal device.

In some embodiments, the terminal device evaluates the policy rule in the downlink message upon receiving the downlink message, determines the identified and/or unidentified policy rule, and generates the first information based on the identified and/or unidentified policy rule.

For example, the downlink message includes a policy rule configured by the core network (for example, the PCF) for the terminal device. Assuming that the policy rule is a policy rule 1, and the terminal device determines, upon evaluation of the policy rule 1, that the policy rule 1 is identifiable (recognizable, supportable, or usable), then the first information carried in the reply message transmitted by the terminal device to the core network element includes first indication information for indicating identification (recognition, support, or use) of the policy rule. In some embodiments, the first information further includes identification information of the identified (recognized, supported, or used) policy rule 1.

For example, the downlink message includes a policy rule configured by the core network (for example, the PCF) for the terminal device. Assuming that the policy rule is a policy rule 1, and the terminal device determines, upon evaluation of the policy rule 1, that the policy rule 1 is unidentifiable (unrecognizable, unsupportable, or unusable), then the first information carried in the reply message transmitted by the terminal device to the core network element includes second indication information for indicating un-identification (unrecognition, un-support, or unuse) of the policy rule. In some embodiments, the first information further includes identification information of the unidentified (unrecognized, unsupported, or unused) policy rule 1.

For example, the downlink message includes a plurality of policy rules configured by the core network (for example, the PCF) for the terminal device. Assuming that the policy rules include a policy rule 1 and a policy rule 2, and the terminal device determines, upon respective evaluation of the policy rule 1 and the policy rule 2, and the policy rule 1 is identifiable (recognizable, supportable, or usable) and the policy rule 2 is unidentifiable (unrecognizable, unsupportable, or unusable), then the first information carried in the reply message transmitted by the terminal device to the core network element is configured to indicate that the terminal device identifies (recognizes, supports, or uses) the policy rule 1, the terminal device does not identifies (recognizes, supports, or uses) the policy rule 2, or the terminal device identifies (recognizes, supports, or uses) the policy rule 1 and the terminal device does not identify (recognize, support, or use) the policy rule 2.

In some embodiments, the reply message is contained in a first container. The terminal device places the reply message in the first container, and transmits the reply message to the core network element through the first container. In some embodiments, the core network element is the PCF, the terminal device first transmits the reply message to the AMF through the first container, and then the AMF does not sense/modify the reply message and transmits the reply message to the PCF.

In some embodiments, the first information reuses an existing field in the reply message. The existing field in the reply message indicates an already defined field in the reply message, and a format or field of the reply message is not modified by reusing the existing field to carry the first information.

In some embodiments, the first information uses a newly added field in the reply message. The newly added field in the reply message indicates that a field is newly added in the reply message to carry the first information in the relay message, and the modification on the relay message is also less in such mode.

In some embodiments, the first information is transmitted over the reply message in a newly defined format. In the above two modes, the first information is carried by the relay message in an original format. In this mode, a format is newly defined for the relay message, and the first information is transmitted in the newly defined format, which is more flexible than the above two modes but requires to redefine the format of the relay message.

The technical solutions according to the present disclosure are described by taking the downlink message being the UCU message and the terminal device transmitting the first information in the relay message corresponding to the UCU message as an example. For example, the terminal device adds the first information in the relay message corresponding to the UCU message, and the first information is configured to indicate the URSP rule identifiable (recognizable, supportable, or usable) by the terminal device.

The core network element (for example, the PCF) transmits the UCU message for UE policy configuration/update to the terminal device, and the UCU message includes the URSP rule configured by the core network. Upon receiving the UCU message, the terminal device evaluates the URSP rule in the UCU message, and determines whether to support parameters in the URSP rule. In the case that one or more parameters in the URSP rule are not supported, the terminal device determines to not support (recognize, support, or use) the URSP rule. Alternatively, in the case that one or more parameters in an RSD of the URSP rule are not supported, the terminal device determines to not support (recognize, support, or use) the RSD of the URSP rule, and determines to support other RSDs of the URSP rule (or all RSDs of the URSP rule are not supported).

The terminal device carries the first information in the relay message corresponding to the UCU message for indicating the URSP rule and/or RSD supported (and/or unsupported) by the terminal device. The first information is also referred to as UE policy enforcement information, URSP rule enforcement information, or other names, which is not limited in the present disclosure.

As in the case that the policy rule is delivered to the terminal device over the UCU message, the policy rule may be delivered in a plurality of policy sections, and each of the plurality of policy sections corresponds to one policy section code, the terminal device makes a confirmation regarding whether a URSP rule and/or an RSD thereof in each of the plurality of policy sections is supported (recognized, supported, or used) in the reply message.

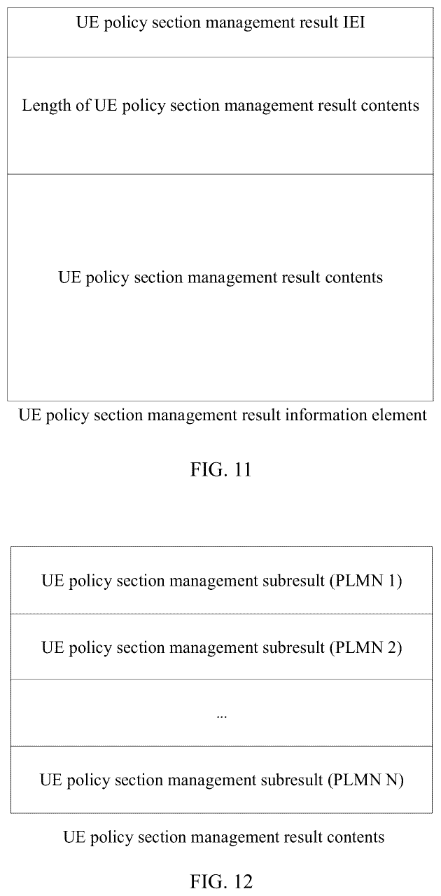

Referring to FIG. 11 to FIG. 15, schematic diagrams of formats of a reply message corresponding to a UCU message are shown. The formats shown in FIG. 11 to FIG. 15 are nested layer by layer.

In particular, FIG. 11 is a schematic diagram of a format of a UE policy section management result information element. It can be seen from FIG. 11 that the policy section management result information element includes a UE policy section management result information element identifier (IEI), a length of UE policy section management result content, and UE policy section management result content.

FIG. 12 is a schematic diagram of a format of UE policy section management result content. It can be seen from FIG. 12 that the UE policy section management result content includes a plurality of UE policy section management sub-results, for example, UE policy section management sub-results corresponding to PLMN 1, PLMN 2, . . . , PLMN N.

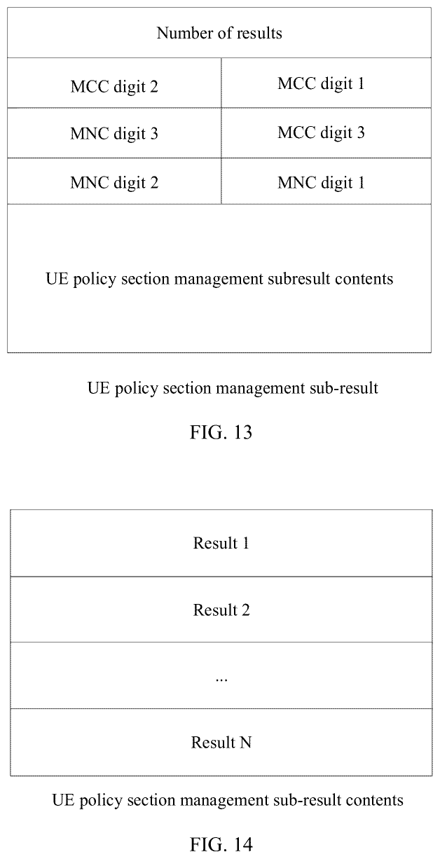

FIG. 13 is a schematic diagram of a format of a UE policy section management sub-result. It can be seen from FIG. 13 that the UE policy section management sub-result includes a number of results, a plurality of mobile country code (MCC) digits, a plurality of mobile network code (MNC) digits, and UE policy section management sub-result content.

FIG. 14 is a schematic diagram of a format of UE policy section management sub-result content. It can be seen from FIG. 14 that the UE policy section management sub-result content includes a plurality of results, for example, Result 1, Result 2, . . . , Result N.

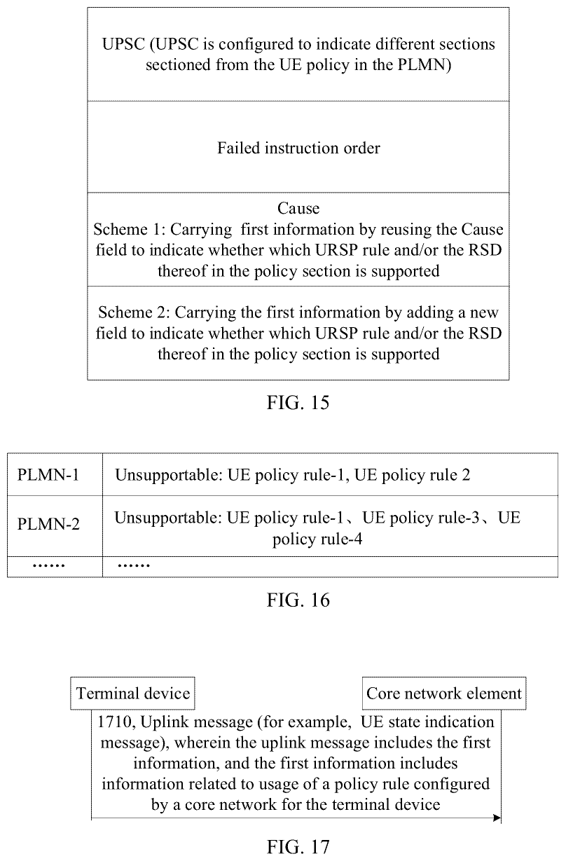

FIG. 15 is a schematic diagram of a format of a Result. It can be seen from FIG. 15 that the Result includes UPSC (for indicating different sections sectioned from the UE policy in the PLMN), Failed Instruction Order, Cause, and other fields.

In some embodiments, the terminal device carries the first information by the existing field in the reply message corresponding to the UCU message. As shown in FIG. 15, for scheme 1, the terminal device carries the first information by reusing the Cause field to indicate whether which URSP rule and/or the RSD thereof in the policy section is supported (recognized, supported, or used).

In some embodiments, the terminal device carries the first information by the newly added field in the reply message corresponding to the UCU message. As shown in FIG. 15, for scheme 2, the terminal device carries the first information by adding a new field to indicate whether which URSP rule and/or the RSD thereof in the policy section is supported (recognized, supported, or used).

In some embodiments, the terminal device transmits the first information by the reply message in a newly defined format. For example, as shown in FIG. 16, the terminal device does not perform the policy section on the reply message corresponding to the UCU message, and newly defines a table indicating that the terminal device supports (or does not support) the URSP rule and/or the RSD thereof. For example, the table includes items corresponding to a plurality of PLMNs, and each of the items indicates the URSP rule and/or the RSD thereof supported (or unsupported) in the PLMN.

In the embodiments, the first information indicating the usage of the policy rule on the terminal device is carried in the reply message corresponding to the downlink message (for example, the UCU message), such that the core network element acquires the usage of the policy rule on the terminal device, and the subsequent configuration and update of the policy rule are facilitated, and the communication reliability is improved.

Referring to FIG. 17, a flowchart of a method for wireless communication according to some embodiments of the present disclosure is shown. The method is applicable to the network architecture shown in FIG. 1 to FIG. 3. The method includes the following processes.

In S1710, a terminal device transmits an uplink message to a core network element, wherein the uplink message includes the first information, and the first information includes information related to usage of a policy rule configured by a core network for the terminal device.

Correspondingly, the core network element receives the uplink message from the terminal device. For descriptions of the first information, reference may be made to content in other embodiments herein, which are not described again.

In the embodiments, the terminal device actively transmits the uplink message to the core network element to report the information related to the usage of the policy rule on the terminal device.

In some embodiments, the uplink message is a UE state indication message (also referred to as a UE STATE INDICATION message).

In some embodiments, the terminal device transmits a registration request message to the core network element, the registration request message includes a second container, and the second container includes the uplink message (for example, the UE state indication message). In some embodiments, the core network element is the PCF, the terminal device transmits the registration request message to the AMF, the registration request message includes the second container, the second container carries the uplink message including the first information, and the AMF forwards the information in the second container upon receiving the registration request message.

In some embodiments, the registration request message includes, but is not limited to, at least one of an initial registration request message, a periodic registration request message, or an address-updated registration request message. The initial registration request message is a registration request message transmitted by the terminal device to the core network device at initial power up of the terminal device. The periodic registration request message is a registration request message periodically transmitted to the core network device by the terminal device. The address-updated registration request message is a registration request message transmitted by the terminal device to the core network device in the case that the address of the terminal device is updated.

In some embodiments, in the case that the first information changes, the terminal device transmits a registration request message including the changed first information to the core network element. For example, in the case that the first information changes, the terminal device actively transmits the registration request message to the core network element, and the registration request message includes the changed first information, such that the changed first information is reported to the core network element timely.

In some embodiments, in the case that the first information changes, the terminal device carries, in response to a trigger of another cause, the changed first information in the registration request message transmitted to the core network element. In some embodiments, the another cause includes, but is not limited to, the existing cause for triggering the registration request message, for example, the registration request message initiated at the initial power up, expiration of the periodic timer, shift outside the registration region, update of a capability of the terminal, and other conditions.

In some embodiments, the terminal device carries the first information by the newly added field in the uplink message. For example, by taking the uplink message being the UE state indication information as an example, a field is added in the UE state indication information to carry the first information. In some embodiments, the existing field in the uplink message is reused to carry the first information, or the uplink message is another uplink messages than the UE state indication information, which is not limited in the present disclosure.

The technical solutions according to the present disclosure are described by taking the uplink message being the UE state indication information and the terminal device transmitting the first information in the UE state indication information as an example. The Table 3 illustrates a schematic diagram of message content of the UE state indication information.

TABLE 3
UE STATE INDICATION message content

| | Information | | | | |
|---|---|---|---|---|---|
| IEI | Element | Type/Reference | Presence | Format | Length |
| | PTI | Procedure | M | V | 1 |
| | | transaction | | | |
| | | identity 9.6 | | | |
| | UE STATE | UE policy | M | V | 1 |
| | INDICATION | delivery service | | | |
| | message | message | | | |
| | identity | type D.6.1 | | | |
| | UPSI list | UPSI list | M | LV-E | 9-65531 |
| | | D.6.4 | | | |
| | UE policy classmark | UE policy | M | LV | 2-4 |
| | | classmark D.6.5 | | | |
| 41 | UE operation | OS Id | 0 | TLV | 18-242 |
| | system (OS) Id | D.6.6 | | | |

NOTE:
The total length of the UE STATE INDICATION message content cannot exceed 65535 octets (see Payload container content maximum length as specified in subclause 9.11.3.39.1).

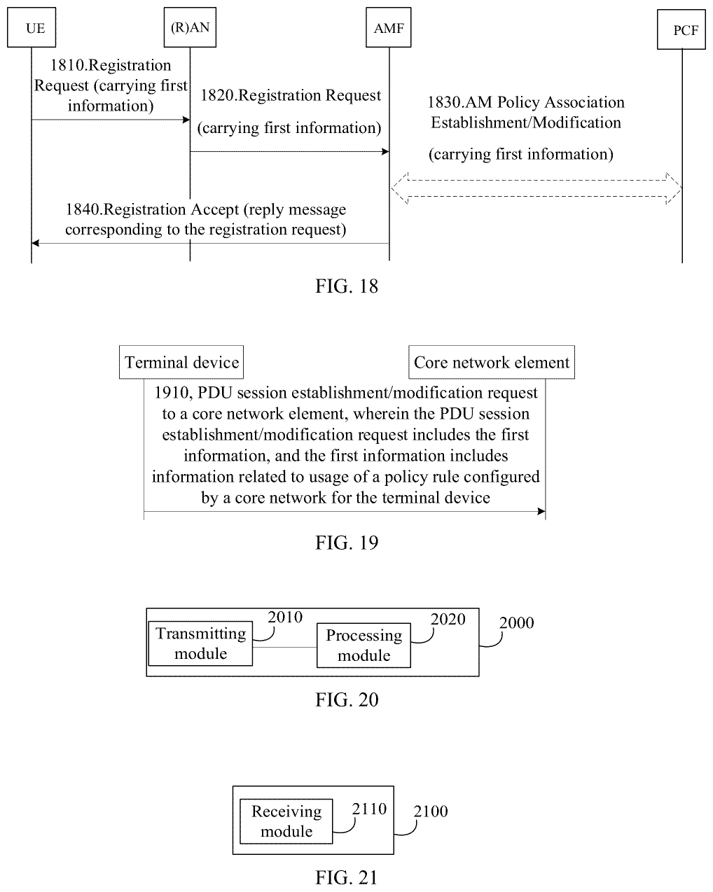

In some embodiments, as shown in FIG. 18, a flowchart of transmission of a registration request message by a terminal device (UE illustrated in the drawing) to a core network element (PCF illustrated in the drawing) is illustrated. The registration request message carries the first information. As shown in FIG. 18, the procedure includes the following processes.
In S1810, a UE transmits a registration request message to the (R)AN.
In S1820, the (R)AN transmits the registration request message to an AMF.
In S1830, an AM policy association establishment/modification procedure is performed between the AMF and a PCF.
In S1840, the AMF transmits a registration accept message to the UE.

In some embodiments, the registration request message includes a container (the “second container” described in the above embodiments), and the container carries the UE state indication information including the first information. In the case that the AMF receives the registration request message, the AMF forwards the information in the container to the PCF in performing the AM policy association establishment/modification procedure between the AMF and the PCF, such that the first information is reported to a network side in the registration request procedure on the terminal. In addition, the registration request message is an initial registration request message, a periodic registration request message, an address-updated registration request message, or the like, which is not limited in the present disclosure.

In some embodiments, the AMF calls a Npcf_UEPolicyControl Service, and the information in the container is forwarded to the PCF by the Npcf_UEPolicyControl Service.

In some embodiments, the reply message corresponding to the registration request message transmitted by the AMF to the UE indicates completion of the registration (for example, the registration accept message), or indicates rejection of the registration, which is not limited in the present disclosure.

In the embodiments, the first information indicating the usage of the policy rule on the terminal device is carried in the uplink message (for example, the UE state indication information), such that the usage of the policy rule is actively reported, the core network element acquires the usage of the policy rule on the terminal device, and the subsequent configuration and update of the policy rule are facilitated, and the communication reliability is improved.

Referring to FIG. 19, a flowchart of a method for wireless communication according to some embodiments of the present disclosure is shown. The method is applicable to the network architecture shown in FIG. 1 to FIG. 3. The method includes the following processes.

In S1910, a terminal device transmits a PDU session establishment/modification request to a core network element, wherein the PDU session establishment/modification request includes the first information, and the first information includes information related to usage of a policy rule configured by a core network for the terminal device.

Correspondingly, the core network element receives the PDU session establishment/modification request from the terminal device. For descriptions of the first information, reference may be made to content in other embodiments herein, which are not described again.

In the embodiments, the terminal device carries the first information to be reported to the core network in the PDU session establishment request and/or the PDU session modification request. For descriptions of the PDU session establishment/modification, reference may be made to content in other embodiments herein, which are not described again.

In some embodiments, the terminal device transmits the PDU session establishment/modification request to the core network element, and the PDU session establishment/modification request includes PDU session parameters and the first information. In some embodiments, the terminal device transmits the PDU session establishment/modification request to the SMF, and the SMF transmits the reply message of the PDU session establishment/modification request to the terminal device upon receiving the PDU session establishment/modification request. In the case that the SMF rejects the PDU session establishment/modification request, the reply message of the PDU session establishment/modification request includes a rejection cause value. In some embodiments, the terminal device adjusts a parameter component based on RSD parameters of the URSP rule to reinitiate the PDU session modification request, and the SMF replies upon receiving the PDU session modification request. In addition, in the case that the PDU session establishment/modification request includes the first information, the SMF acquires the first information upon receiving the PDU session establishment/modification request, and transmits the first information to the PCF.

In some embodiments, in the case that the first information changes, the terminal device transmits a PDU session establishment/modification request including the changed first information to the core network element. For example, in the case that the first information changes, the terminal device actively transmits the PDU session establishment/modification request to the core network element, and the PDU session establishment/modification request includes the changed first information, such that the changed first information is reported to the core network element timely.

In some embodiments, in the case that the first information changes, the terminal device carries, in response to a trigger of another cause, the changed first information in the PDU session establishment/modification request transmitted to the core network element. In some embodiments, the another cause includes, but is not limited to, the existing cause for triggering the PDU session establishment/modification request, for example, meeting an establishment condition of the PDU session, meeting a modification condition of the PDU session, and the like, which is not limited in the present disclosure.

In some embodiments, the terminal device carries the first information by the newly added field in the PDU session establishment/modification request. For example, a field is added in the PDU session establishment/modification request to carry the first information. In some embodiments, the existing field in the PDU session establishment/modification request is reused to carry the first information, which is not limited in the present disclosure.

In the embodiments, the first information indicating the usage of the policy rule on the terminal device is carried in the PDU session establishment/modification request, such that the usage of the policy rule is actively reported, the core network element acquires the usage of the policy rule on the terminal device, and the subsequent configuration and update of the policy rule are facilitated, and the communication reliability is improved.

In the embodiments shown in FIG. 10, FIG. 17, and FIG. 19, several different modes for reporting the first information are described, which include reporting the first information based on the UCU procedure, reporting the first information based on the registration procedure on the terminal, reporting the first information based on the PDU session establishment/modification procedure, and the like. It should be understood that the terminal device carries the first information in other uplink messages or the reply message corresponding to the downlink message to report the first information to the core network, which shall fall within the scope of the protection of the present disclosure, and the embodiments of the present disclosure would not illustrate in detail.

In some embodiments, prior to transmission of the first information from the terminal device to the core network element, there are processes described in the following illustrative embodiments.

In some embodiments, the terminal device transmits a first indication to the core network element, and correspondingly, the core network element receives the first indication from the terminal device. The first indication indicates that the terminal device supports reporting the first information and/or at least one sub-information in the first information. In the embodiments, the core network element is a PCF.

The above first indication is also regarded as an indication of the capability of the terminal device, and is configured to inform the network device whether the terminal device supports (requests, allows, or requires, that is, the parameter is capable of informing the network device that the terminal device is capable of reporting the first information) reporting the first information, and/or is configured to inform the network device that report of which piece or pieces of sub-information in the first information is supported (requested, allowed, or required, that is, the parameter is capable of informing the terminal side that the first information is required to be reported) by the terminal device. For example, the first indication indicates that the terminal device supports reporting the first information, and supports reporting first sub-information and second sub-information in the first information. For descriptions of the first information and the sub-information in the first information, reference may be made to the above embodiments, which are not repeated again herein.

Upon receiving the first indication, the core network element determines whether to allow the terminal device in reporting the first information, and/or which piece or pieces of sub-information in the first information is allowed or disallowed to be reported by the terminal device, and then the determination result is transmitted to the terminal device, such that the terminal device reports the first information based on requirements of the network side.

In some embodiments, the core network element transmits a second indication to the terminal device, and the terminal device receives the second indication from the core network element. The second indication indicates that the core network element supports the terminal device in reporting the first information and/or at least one sub-information in the first information. In the embodiments, the core network element is the PCF.

The above second indication is also regarded as a requirement indication of the network side, and is configured to inform the terminal device whether the core network supports (allows, or requests) reporting the first information, and/or is configured to inform the terminal device that report of which piece or pieces of sub-information in the first information is supported (allowed, or requested) by the terminal device. For example, the second indication indicates that the core network supports reporting the first information, and supports reporting first sub-information and third sub-information in the first information. For descriptions of the first information and the sub-information in the first information, reference may be made to the above embodiments, which are not repeated again herein.

Upon receiving the second indication, the terminal device determines whether to report the first information to the core network, and/or which piece or pieces of sub-information in the first information is reported, such that the terminal device reports the first information based on the requirements of the network side.

In the above embodiments, the terminal device transmits the first indication to the core network element, and subsequently reports the first information to the core network element based on the first indication. For example, the first indication indicates that the terminal device supports reporting the first information and the first sub-information and the second sub-information in the first information, and thus the first information reported by the terminal device to the core network element includes the first sub-information and the second sub-information. Correspondingly, upon receiving the first indication, the core network element determines, based on the first indication, whether the terminal device reports the first information, and which piece or pieces of sub-information in the first information is reported in the case that the first information is reported, such that the first information is accurately received. It should be noted that in the embodiments, the terminal device transmits the first indication to the core network element, but the core network element does not need to transmit the second indication to the terminal device.

In some embodiments, the core network element transmits the second indication to the terminal device, and subsequently the terminal device reports the first information to the core network element based on the second indication. For example, in the case that the second indication indicates that the core network element supports the terminal device in reporting the first information, the terminal device reports the first information to the core network element; and in the case that the second indication indicates that the core network element does not support the terminal device in reporting the first information, the terminal device does not report the first information to the core network element. For example, in the case that the second indication indicates that the core network element supports the terminal device in reporting one or more pieces of sub-information in the first information, the first information reported by the terminal device to the core network element carries the sub-information supported by the core network element, and sub-information unsupported by the core network element does not need to be reported, such that unnecessary information transmission is avoided. It should be noted that in the embodiments, the core network element transmits the second indication to the terminal device, but the terminal device does not need to transmit the first indication to the core network element.

In addition, for the procedure of transmission of the first indication by the terminal device and the procedure of transmission of the second indication by the core network element, one of the two processes are selected to perform, or the two processes are performed. In the case that the two processes are performed, a negotiation procedure between the terminal device and the core network is practiced.

In some embodiments, the terminal device transmits the first indication to the core network element, and the first indication indicates that the terminal device supports reporting the first information and/or at least one sub-information in the first information; and the core network element transmits the second indication to the terminal device, and the second indication indicates that the core network element supports the terminal device in reporting the first information and/or at least one sub-information in the first information. That is, in the negotiation procedure, the terminal device transmits the first indication to the core network element, and the core network element transmits the second indication to the terminal device. The sequence of transmitting the first indication and the second indication is not limited in the present disclosure. The terminal device first transmits the first indication to the core network element, and then the core network element transmits the second indication to the terminal device. Alternatively, the core network element first transmits the second indication to the terminal device, and then the terminal device transmits the first indication to the core network element. Alternatively, the transmission processes of the first indication and the second indication are simultaneously performed, which is not limited in the present disclosure.

For example, the first indication indicates that the terminal device supports reporting the first information and the first sub-information and the second sub-information in the first information, and the second indication indicates that the core network supports the terminal device in reporting the first information and the first sub-information and the third sub-information in the first information. Thus, based on the above negotiation procedure, the terminal device reports the first information and the first sub-information, and the second sub-information and the third sub-information are not reported (not reported even if the second sub-information and the third sub-information exist), such that the network side controls information report of the terminal, unnecessary information transmission is avoided, and transmission resources are saved. In addition, based on the negotiation procedure, the terminal device and the core network reach an agreement on whether to report the first information and which piece or pieces of sub-information in the first information to be reported, such that the collaboration and consistency between the terminal device and the core network are improved.

In addition, transmission of the first indication and transmission of the second indication are achieved in the UCU procedure or in the registration procedure on the terminal. In some embodiments, the first indication and the second indication are transmitted through a specific message, or transmitted by carrying in another existing message, which is not limited in the present disclosure.

In some embodiments, in the case that the first information is reported in the UCU procedure, the UCU message transmitted by the core network element to the terminal device includes the second indication, and/or the reply message corresponding to the UCU message includes the first indication.

In addition, in the case that the terminal device transmits the first indication through the reply message corresponding to the UCU message, and the terminal device determines to report the first information, the first information is carried in the reply message corresponding to the UCU message, or the first information is transmitted upon transmission of the reply message corresponding to the UCU message, which is not limited in the present disclosure.

In some embodiments, in the case that the first information is reported in the registration procedure on the terminal, the registration request message transmitted by the terminal device to the core network element includes the first indication, and/or the reply message corresponding to the registration request message includes the second indication.

In addition, in the case that the terminal device transmits the first indication through the registration request message, and the terminal device determines to report the first information, the first information is carried in the registration request message, or the first information is transmitted upon receipt of the reply message corresponding to the registration request message, which is not limited in the present disclosure.

In some embodiments, in the case that the first information is reported in the PDU session establishment/modification procedure, the PDU session establishment/modification request transmitted by the terminal device to the core network element includes the first indication, and/or the reply message corresponding to the PDU session establishment/modification request includes the second indication.

In addition, in the case that the terminal device transmits the first indication through the PDU session establishment/modification request, and the terminal device determines to report the first information, the first information is carried in the PDU session establishment/modification request, or the first information is transmitted upon receipt of the reply message corresponding to the PDU session establishment/modification request, which is not limited in the present disclosure. In the embodiments of the present disclosure, based on the first indication and/or the second indication, the network side controls the information report of the terminal, the unnecessary information transmission is avoided, and the transmission resources are saved.

The following are apparatus embodiments of the present disclosure, which are used to implement method embodiments of the present disclosure. For details not disclosed in the apparatus embodiments of the present disclosure, reference may be made to the method embodiments of the present disclosure.

Referring to FIG. 20, a schematic block diagram of an apparatus for wireless communication according to some embodiments of the present disclosure is shown. The apparatus may be implemented as the terminal device or a part of the terminal device. As shown in FIG. 20, the apparatus 2000 includes a transmitting module 2010.

The transmitting module 2010 is configured to transmit first information to a core network element, wherein the first information includes information related to usage of a policy rule configured by a core network for the terminal device.

In some embodiments, the first information further includes at least one of:
first sub-information, indicating an identified and/or unidentified policy rule;
second sub-information, indicating a policy rule used in establishing a PDU session;
third sub-information, indicating a policy rule used for one or more applications;
a fourth sub-information, indicating the PDU session and/or a network slice used for one or more applications; or
fifth sub-information, indicating whether the terminal device uses an updated policy rule and/or indicating a policy rule used by the terminal device.

In some embodiments, the second sub-information further indicates a mapping relationship between the PDU session and the policy rule used in establishing the PDU session.

In some embodiments, the third sub-information further indicates at least one policy rule used for the one or more applications at different times or within different periods.

In some embodiments, the network slice is identified by S-NSSAI.

In some embodiments, the transmitting module 2010 is configured to: upon receipt of a downlink message from a core network element, transmit a reply message corresponding to the downlink message to the core network element, wherein the reply message includes the first information.

In some embodiments, as shown in FIG. 20, the apparatus 2000 further includes a processing module 2020, wherein the processing module is configured to: upon receipt of the downlink message, evaluate a policy rule in the downlink message, and determine an identified and/or unidentified policy rule; and generate the first information based on the identified and/or unidentified policy rule.

In some embodiments, the reply message is contained in a first container.

In some embodiments, the downlink message is a UCU message.

In some embodiments, the first information reuses an existing field in the reply message, or the first information uses a newly added field in the reply message.

In some embodiments, the first information is transmitted over the reply message in a newly defined format.

In some embodiments, the transmitting module 2010 is further configured to transmit an uplink message to the core network element, wherein the uplink message includes the first information.

In some embodiments, the transmitting module 2010 is further configured to transmit a registration request message to the core network element, wherein the registration request message includes a second container, the second container including the uplink message.

In some embodiments, the registration request message includes at least one of: an initial registration request message, a periodic registration request message, or an address-updated registration request message.

In some embodiments, the transmitting module 2010 is further configured to: in response to change of the first information, transmit a registration request message including the changed first information to the core network element, or carry, in response to a trigger of another cause, the changed first information in the registration request message transmitted to the core network element.

In some embodiments, the uplink message is a UE state indication message.

In some embodiments, a newly added field in the uplink message carries the first information.

In some embodiments, the transmitting module 2010 is further configured to transmit a PDU session establishment/modification request to the core network element, wherein the PDU session establishment/modification request includes the first information.

In some embodiments, the transmitting module 2010 is further configured to transmit a first indication to the core network element, wherein the first indication indicates that the terminal device supports reporting the first information and/or at least one sub-information in the first information; and/or

the apparatus further includes a receiving module (not shown in FIG. 20), configured to receive a second indication from the core network element, wherein the second indication indicates that the core network element supports the terminal device in reporting the first information and/or at least one sub-information in the first information.

In some embodiments, in the case that the first information is reported based on a UCU procedure, a UCU message transmitted by the core network element to the terminal device includes the second indication, and/or a reply message corresponding to the UCU message includes the first indication.

In some embodiments, in the case that the first information is reported based on a terminal registration procedure, a registration request message transmitted by the terminal device to the core network element includes the first indication, and/or a reply message corresponding to the registration request message includes the second indication.

In some embodiments, in the case that the first information is reported based on a PDU session establishment/modification procedure, a PDU session establishment/modification request transmitted by the terminal device to the core network element includes the first indication, and/or a reply message corresponding to the PDU session establishment/modification request includes the second indication.

In some embodiments, identification of the policy rule includes at least one of:
identifying the policy rule using a rule ID of the policy rule; or
identifying the policy rule using one or more parameters of the policy rule.

In some embodiments, in the case that the policy rule is a URSP rule, identifying the policy rule using the one or more parameters of the policy rule includes:

identifying the URSP rule using a traffic descriptor and/or rule precedence of the URSP rule; and/or identifying the RSD in the URSP rule using precedence and/or route selection components of an RSD in the URSP rule.

In some embodiments, the policy rule includes at least one of: a URSP rule, a V2XP rule, a ProSeP rule, or an ANDSP rule.

Referring to FIG. 21, a schematic block diagram of an apparatus for wireless communication according to some embodiments of the present disclosure is shown. The apparatus may be implemented as the core network element or a part of the core network element. As shown in FIG. 21, the apparatus 21000 includes a receiving module 2110.

The receiving module 2110 is configured to receive first information from a terminal device, wherein the first information includes information related to usage of a policy rule configured by a core network for the terminal device.

In some embodiments, the first information further includes at least one of:
first sub-information, indicating an identified and/or unidentified policy rule;
second sub-information, indicating a policy rule used in establishing a PDU session;
third sub-information, indicating a policy rule used for one or more applications;
fourth sub-information, indicating the PDU session and/or a network slice used for one or more applications; or
fifth sub-information, indicating whether the terminal device uses an updated policy rule and/or indicating a policy rule used by the terminal device.

In some embodiments, the second sub-information further indicates a mapping relationship between the PDU session and the policy rule used in establishing the PDU session.

In some embodiments, the third sub-information further indicates at least one policy rule used for the one or more applications at different times or within different periods.

In some embodiments, the network slice is identified by S-NSSAI.

In some embodiments, the receiving module 2110 is further configured to: upon transmission of a downlink message from a core network element to the terminal device, receive a reply message corresponding to the downlink message from the terminal device, wherein the reply message includes the first information.

In some embodiments, a policy rule in the downlink message is configured to be evaluated by the terminal device, and the first information is generated upon determination of an identified and/or unidentified policy rule.

In some embodiments, the reply message is contained in a first container.

In some embodiments, the downlink message is a UCU message.

In some embodiments, the first information reuses an existing field in the reply message, or the first information uses a newly added field in the reply message.

In some embodiments, the first information is transmitted over the reply message in a newly defined format.

In some embodiments, the receiving module 2110 is further configured to receive an uplink message from the terminal device, wherein the uplink message includes the first information.

In some embodiments, the receiving module 2110 is further configured to receive a registration request message from the terminal device, wherein the registration request message includes a second container, the second container including the uplink message.

In some embodiments, the registration request message includes at least one of: an initial registration request message, a periodic registration request message, or an address-updated registration request message.

In some embodiments, the receiving module 2110 is further configured to: in response to change of the first information, receive a registration request message including the changed first information from the terminal device, or carry, in response to a trigger of another cause, the changed first information in the registration request message transmitted by the terminal device. In some embodiments, the uplink message is a UE state indication message.

In some embodiments, a newly added field in the uplink message carries the first information.

In some embodiments, the receiving module 2110 is further configured to receive a PDU session establishment/modification request from the terminal device, wherein the PDU session establishment/modification request includes the first information.

In some embodiments, the receiving module 2110 is further configured to: receive a first indication from the terminal device, wherein the first indication indicates that the terminal device supports reporting the first information and/or at least one sub-information in the first information; and/or

the apparatus further includes a transmitting module (not shown in FIG. 21), configured to transmit a second indication to the terminal device, wherein the second indication indicates that the core network element supports the terminal device in reporting the first information and/or at least one sub-information in the first information.

In some embodiments, in the case that the first information is reported based on a UCU procedure, a UCU message transmitted by the core network element to the terminal device includes the second indication, and/or a reply message corresponding to the UCU message includes the first indication.

In some embodiments, in the case that the first information is reported based on a terminal registration procedure, a registration request message transmitted by the terminal device to the core network element includes the first indication, and/or a reply message corresponding to the registration request message includes the second indication.

In some embodiments, in the case that the first information is reported based on a PDU session establishment/modification procedure, a PDU session establishment/modification request transmitted by the terminal device to the core network element includes the first indication, and/or a reply message corresponding to the PDU session establishment/modification request includes the second indication.

In some embodiments, identification of the policy rule includes at least one of:
identifying the policy rule using a rule ID of the policy rule; or
identifying the policy rule using one or more parameters of the policy rule.

In some embodiments, in the case that the policy rule is a URSP rule, identifying the policy rule using the one or more parameters of the policy rule includes: identifying the URSP rule using a traffic descriptor and/or rule precedence of the URSP rule; and/or identifying the RSD in the URSP rule using precedence and/or route selection components of an RSD in the URSP rule.

In some embodiments, the policy rule includes at least one of: a URSP rule, a V2XP rule, a ProSeP rule, or an ANDSP rule.

In some embodiments, in the case that the policy rule is a URSP rule, the policy rule indicated by the first information includes the URSP rule and/or at least one RSD in the URSP rule.

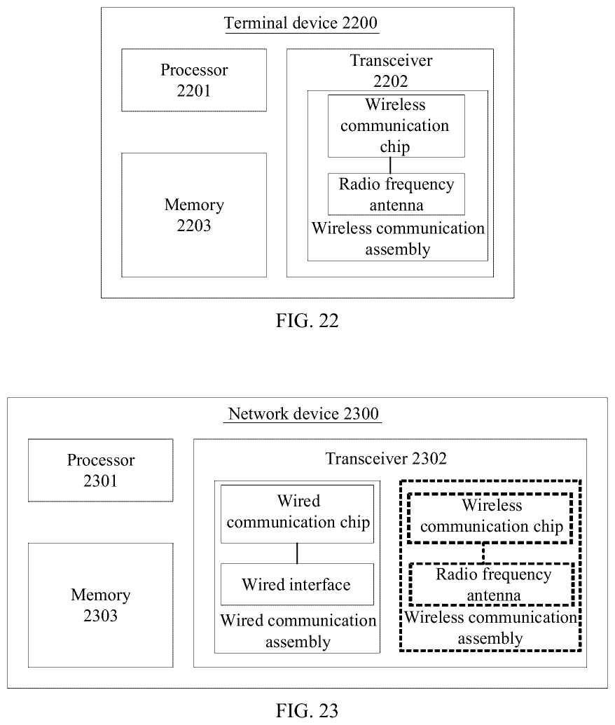

Referring to FIG. 22, a schematic block diagram of a terminal device according to some embodiments of the present disclosure is shown. The terminal device 2200 includes: a processor 2201, a transceiver 2202, and a memory 2203.

The processor 2201 includes one or more processing cores, and achieves various functional applications and information processing by running software programs and modules.

The transceiver 2202 includes a receiver and a transmitter. For example, the receiver and the transmitter are practiced as a communication assembly, and the communication assembly includes a wireless communication chip and a radio frequency antenna.

The memory 2203 is connected to the processor 2201 and the transceiver 2202.

The memory 2203 is configured to store one or more computer programs, and the processor 2201, when loading and running the one or more computer programs, is caused to perform various processes performed by the terminal device in the above method embodiments.

In addition, the memory 2203 is achieved by any type of volatile or non-volatile storage device or combinations thereof. The volatile or non-volatile storage device includes, but is not limited to, a disk or optical disc, an electrically-erasable programmable read only memory, an erasable programmable read only memory, a static random access memory, a read-only memory (ROM), a magnetic memory, a flash memory, or a programmable read-only memory.

In some embodiments, the transceiver 2202 is configured to transmit the first information to the core network element, and the first information includes information related to usage of a policy rule configured by a core network for the terminal device.

For details not described in the embodiments, reference may be made to the above embodiments, which is not described herein again.

Referring to FIG. 23, a schematic block diagram of a network device according to some embodiments of the present disclosure is shown. The network device 2300 includes: a processor 2301, a transceiver 2302, and a memory 2303.

The processor 2301 includes one or more processing cores, and achieves various functional applications and information processing by running software programs and modules.

The transceiver 2302 includes a receiver and a transmitter. For example, the transceiver 2302 includes a wired communication assembly, and the wired communication assembly includes a wired communication chip and a wired interface (for example, a fiber Interface). In some embodiments, the transceiver 2302 includes a wireless communication assembly, and the wireless communication assembly includes a wireless communication chip and a radio frequency antenna. The memory 2303 is connected to the processor 2301 and the transceiver 2302.

The memory 2303 is configured to store one or more computer programs, and the processor 2301, when loading and running the one or more computer programs, is caused to perform various processes performed by the core network element in the above method embodiments.

In addition, the memory 2303 is achieved by any type of volatile or non-volatile storage device or combinations thereof. The volatile or non-volatile storage device includes, but is not limited to, a disk or optical disc, an electrically-erasable programmable read only memory, an erasable programmable read only memory, a static random access memory, a read-only memory, a magnetic memory, a flash memory, or a programmable read-only memory.

In some embodiments, in the case that the network device is the core network element, the transceiver 2302 is configured to receive the first information to from the terminal device, and the first information includes information related to usage of a policy rule configured by a core network for the terminal device.

For details not described in the embodiments, reference may be made to the above embodiments, which is not described herein again.

Some embodiments of the present disclosure further provide a computer-readable storage medium storing one or more computer programs, wherein the one or more computer programs, when loaded and executed by a processor in a terminal device, cause the terminal device to perform the above method for wireless communication applicable to the terminal device side.

Some embodiments of the present disclosure further provide a computer-readable storage medium storing one or more computer programs, wherein the one or more computer programs, when loaded and executed by a processor in a network device (for example, a core network element), cause the network device (for example, the core network element) to perform the above method for wireless communication applicable to the terminal device (for example, the core network element) side.

In some embodiments, the computer-readable storage medium includes: a ROM, a random access memory (RAM), a solid state drive (SSD), an optical disc, or the like. The RAM includes a resistance random access memory (ReRAM) and a dynamic random access memory (DRAM).

Some embodiments of the present disclosure further provide a chip. The chip includes programmable logic circuitry and/or program instructions, wherein the chip, when running on a terminal device, causes the terminal device to perform the above method for wireless communication applicable to the terminal device.

Some embodiments of the present disclosure further provide a chip. The chip includes programmable logic circuitry and/or program instructions, wherein the chip, when running on a network device (for example, a core network element), causes the network device (for example, the core network element) to perform the above method for wireless communication applicable to the network device (for example, the core network element).

Some embodiments of the present disclosure further provide a computer program product or a computer program including one or more computer instructions therein. The one or more computer instructions are stored in a computer-readable storage medium, and when loaded and executed by a processor in a terminal device, cause the terminal device to perform the above method for wireless communication applicable to the terminal device.

Some embodiments of the present disclosure further provide a computer program product or a computer program including one or more computer instructions therein. The one or more computer instructions are stored in a computer-readable storage medium, and when loaded and executed by a processor in a network device (for example, a core network element), cause the network device (for example, the core network element) to perform the above method for wireless communication applicable to the network device (for example, the core network element).

It should also be understood that the term “indication” in the embodiments of the present disclosure refers to direct or indirect indication, or an associated relationship. Illustratively, in the case that A indicates B, it means that: A directly indicates B, for example, B can be acquired through A; A indirectly indicates B, for example, A indicates C, and B can be acquired through C; or A and B have an association relationship.

In some embodiments of the present disclosure, the term “correspondence” means that there is a direct correspondence or indirect correspondence between the two objects, there is an association between the two objects, or there is a relationship of indicating and being indicated, configuring and being configured, or the like.

In some embodiments of the present disclosure, the terms “predefined” is achieved by pre-storing corresponding codes or forms in the device (including, for example, a network device and a terminal device) or other means for indicating relevant information, and specific implementations are not limited in the present disclosure. For example, the predefinition is defined in the protocol.

In some embodiments of the present disclosure, the “protocol” is a standard protocol in the communication field, and includes, for example, an LTE protocol, an NR protocol, and related protocols used in the future communication system, which is not limited in the present disclosure.

The term “a plurality of” herein means two or more. The term “and/or” herein describes associations between associated objects, and indicates three types of relationships. For example, the phrase “A and/or B” means (A), (B), or (A and B). The symbol “/” generally indicates an “or” relationship between the associated objects.

In addition, the serial number of the processes described herein only illustrates a possible sequence of performing the processes. In some embodiments, the above processes may be not performed in the above serial number, for example, processes of two different serial numbers are performed simultaneously, or processes of two different serial numbers are performed in an order opposite to that shown in the drawing, which is not limited in the present disclosure.

It should be understood by those skilled in the art that in the above one or more embodiments, functions described in the embodiments of the present disclosure are practiced by the hardware, the software, the firmware or any combinations thereof. In the case that the functions are practiced by the software, the functions are stored in the computer-readable storage medium or are determined as one or more instructions or codes in the computer-readable storage medium for transmission. The computer-readable storage medium includes a computer storage medium and a communication medium, and the communication medium includes any medium facilitating transmission of the computer program from one place to another place. The storage medium is any available medium accessible by a general or specific computer.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

What is claimed is:

1. A method for wireless communication, applicable to a terminal device, the method comprising:
transmitting first information to a core network element, wherein the first information comprises information related to usage of a policy rule configured by a core network for the terminal device.

2. The method according to claim 1, wherein the first information further comprises at least one of:
first sub-information, indicating an identified and/or unidentified policy rule;
second sub-information, indicating a policy rule used in establishing a packet data unit (PDU) session;
third sub-information, indicating a policy rule used for one or more applications;
fourth sub-information, indicating the PDU session and/or a network slice used for one or more applications; or
fifth sub-information, indicating whether the terminal device uses an updated policy rule and/or indicating a policy rule used by the terminal device.

3. The method according to claim 1, wherein transmitting the first information to the core network element comprises:
upon receiving a downlink message from the core network element, transmitting a reply message corresponding to the downlink message to the core network element, wherein the reply message comprises the first information.

4. The method according to claim 3, further comprising:
upon receiving the downlink message, evaluating a policy rule in the downlink message, and determining an identified and/or unidentified policy rule; and
generating the first information based on the identified and/or unidentified policy rule.

5. The method according to claim 3, wherein the reply message is contained in a first container.

6. The method according to claim 1, wherein transmitting the first information to the core network element comprises:
transmitting a packet data unit (PDU) session establishment/modification request to the core network element, wherein the PDU session establishment/modification request comprises the first information.

7. The method according to claim 1, further comprising:
transmitting a first indication to the core network element, wherein the first indication indicates that the terminal device supports reporting the first information and/or at least one sub-information in the first information; and
receiving a second indication from the core network element, wherein the second indication indicates that the core network element supports the terminal device in reporting the first information and/or at least one sub-information in the first information.

8. A communication device, comprising:
a processor; and
a memory storing one or more computer programs, which, when executed by the processor, cause the communication device to:
transmit first information to a core network element, wherein the first information comprises information related to usage of a policy rule configured by a core network for a terminal device.

9. The communication device according to claim 8, wherein the first information further comprises at least one of:
first sub-information, indicating an identified and/or unidentified policy rule;
second sub-information, indicating a policy rule used in establishing a packet data unit (PDU) session;
third sub-information, indicating a policy rule used for one or more applications;
fourth sub-information, indicating the PDU session and/or a network slice used for one or more applications; or
fifth sub-information, indicating whether the terminal device uses an updated policy rule and/or indicating a policy rule used by the terminal device.

10. The communication device according to claim 8, wherein the one or more computer programs, when executed by the processor, further cause the communication device to:
upon receiving a downlink message from the core network element, transmit a reply message corresponding to the downlink message to the core network element, wherein the reply message comprises the first information.

11. The communication device according to claim 10, wherein the one or more computer programs, when executed by the processor, further cause the communication device to:
upon receiving the downlink message, evaluate a policy rule in the downlink message, and determine an identified and/or unidentified policy rule; and
generate the first information based on the identified and/or unidentified policy rule.

12. The communication device according to claim 10, wherein the reply message is contained in a first container.

13. The communication device according to claim 8, wherein the one or more computer programs, when executed by the processor, further cause the communication device to:
transmit a packet data unit (PDU) session establishment/modification request to the core network element, wherein the PDU session establishment/modification request comprises the first information.

14. The communication device according to claim 8, wherein the one or more computer programs, when executed by the processor, further cause the communication device to:
transmit a first indication to the core network element, wherein the first indication indicates that the terminal device supports reporting the first information and/or at least one sub-information in the first information; and
receive a second indication from the core network element, wherein the second indication indicates that the core network element supports the terminal device in reporting the first information and/or at least one sub-information in the first information.

15. A communication device, comprising:
a processor; and
a memory storing one or more computer programs, which, when executed by the processor, cause the communication device to:
receive first information from a terminal device, wherein the first information comprises information related to usage of a policy rule configured by a core network for the terminal device.

16. The communication device according to claim 15, wherein the first information further comprises at least one of:
first sub-information, indicating an identified and/or unidentified policy rule;
second sub-information, indicating a policy rule used in establishing a packet data unit (PDU) session;
third sub-information, indicating a policy rule used for one or more applications;
fourth sub-information, indicating the PDU session and/or a network slice used for one or more applications; or
fifth sub-information, indicating whether the terminal device uses an updated policy rule and/or indicating a policy rule used by the terminal device.

17. The communication device according to claim 15, wherein the one or more computer programs, when executed by the processor, further cause the communication device to:
upon transmitting a downlink message from a core network element to the terminal device, receive a reply message corresponding to the downlink message transmitted by the terminal device, wherein the reply message comprises the first information.

18. The communication device according to claim 17, wherein a policy rule in the downlink message is configured to be evaluated by the terminal device, and the first information is generated upon determination of an identified and/or unidentified policy rule.

19. The communication device according to claim 17, wherein the reply message is contained in a first container.

20. The communication device according to claim 15, wherein the one or more computer programs, when executed by the processor, further cause the communication device to:
receive a packet data unit (PDU) session establishment/modification request from the terminal device, wherein the PDU session establishment/modification request comprises the first information.
